(19) United States
(12) Patent Application Publication
(10) Pub. No.: US 2023/0315510 A1
(43) Pub. Date: Oct. 5, 2023

(54) A TECHNIQUE FOR HANDLING TRANSACTIONS IN A SYSTEM EMPLOYING TRANSACTIONAL MEMORY

(71) Applicant: ARM LIMITED, Cambridge, Cambridgeshire (GB)

(72) Inventors: Timothy HAYES, Cambridge, Cambridgeshire (GB); David Hennah MANSELL, Cambridge, Cambridgeshire (GB); Alasdair GRANT, Cambridge, Cambridgeshire (GB); Guy LARRI, Cambridge, Cambridgeshire (GB)

(21) Appl. No.: 18/245,659

(22) PCT Filed: Aug. 2, 2021
(86) PCT No.: PCT/GB2021/051993

§ 371 Date: Mar. 16, 2023

(30) Foreign Application Priority Data
Sep. 21, 2020 (GB) 2014867.2

(51) Int. Cl. G06F 9/46; G06F 9/30

(52) U.S. Cl. CPC G06F 9/467; G06F 9/30098

(57) ABSTRACT

An apparatus and method are provided for handling transactions in a system employing transactional memory. The apparatus has processing circuitry for performing data processing in response to instructions, and transactional memory support circuitry for supporting execution of a transaction within a thread of data processing by the processing circuitry. The transaction comprises a sequence of instructions executed speculatively and for which the processing circuitry prevents commitment of results of those instructions until the transaction has reached a transaction end point. The transactional memory support circuitry comprises abort event detection circuitry that causes execution of the transaction to be aborted when an abort event is detected before the transaction has reached the transaction end point, and which causes abort status information to be stored for later reference when determining whether to retry execution of the transaction.

### BACKGROUND

The present disclosure relates to the field of data processing. More particularly it relates to transactional memory.

A data processing system may execute a number of threads of data processing. The threads may be executed on the same processing unit, or on separate processing units within the data processing system. Sometimes, the threads may need to access a shared resource and the nature of the data processing operations may be such that once a thread starts interacting with the shared resource, it may be necessary for a set of operations to complete atomically using the resource without another thread accessing the resource in the meantime.

Rather than employing lock-based mechanisms to control exclusive access to at least one target resource in such situations, a technique which has been developed for handling conflicts between threads accessing shared resources involves the use of transactional memory support. In particular, a data processing system may be provided with transactional memory support circuitry to support execution of a transaction, the transaction comprising a sequence of instructions executed speculatively and for which the processing circuitry is configured to prevent commitment of results of the speculatively executed instructions until the transaction has reached a transaction end point. If it becomes necessary to abort the transaction before the transaction end point is reached, for example because another thread is performing a conflicting access, then it is necessary to be able to restore the state of the processor to the state that existed before the transaction started.

By using transactional memory support, this can provide a more optimistic approach for handling conflicts between threads accessing shared resources than if a lock-based mechanism is used. In particular, each thread may optimistically start processing a critical section of code assuming that no conflicts with other threads will occur, and then if the end of the critical section is reached without any conflict being detected the results of the transaction can be committed. In cases where conflict is rare, using transactional memory support can improve performance by allowing more threads to concurrently process their critical sections of code.

However, it is typically considered necessary to provide a fallback path within the software being executed on the data processing system, so that forward progress can be guaranteed if it is not possible to complete certain transactions. Such a fallback path may, for example, use the earlier-mentioned lock-based mechanism. However, since use of the fallback path will typically result in serialisation of the threads, and thus result in performance degradation, it is desirable to avoid use of the fallback path unless absolutely necessary.

### SUMMARY

In one example arrangement, there is provided an apparatus comprising: processing circuitry to perform data processing in response to instructions; and transactional memory support circuitry to support execution of a transaction within a thread of data processing by the processing circuitry, the transaction comprising a sequence of instructions executed speculatively and for which the processing circuitry is configured to prevent commitment of results of the speculatively executed instructions until the transaction has reached a transaction end point; the transactional memory support circuitry comprising abort event detection circuitry to cause execution of the transaction to be aborted when an abort event is detected before the transaction has reached the transaction end point, and to cause abort status information to be stored for later reference when determining whether to retry execution of the transaction; wherein when the abort event arises due to a given exception event of a given type, the abort event detection circuitry is arranged to cause syndrome information to be captured for use when seeking to resolve the given exception event, and to cause the abort status information to identify that a retry of the transaction is suggested at least in the event that the given exception event is resolved.

In another example arrangement, there is provided a method of handling transactions in an apparatus, comprising: employing processing circuitry to perform data processing in response to instructions; employing transactional memory support circuitry to support execution of a transaction within a thread of data processing by the processing circuitry, the transaction comprising a sequence of instructions executed speculatively and for which the processing circuitry is configured to prevent commitment of results of the speculatively executed instructions until the transaction has reached a transaction end point; aborting execution of the transaction when an abort event is detected by the transactional memory support circuitry before the transaction has reached the transaction end point; on aborting execution of the transaction, storing abort status information for later reference when determining whether to retry execution of the transaction; and when the abort event arises due to a given exception event of a given type, capturing syndrome information for use when seeking to resolve the given exception event, and causing the abort status information to identify that a retry of the transaction is suggested at least in the event that the given exception event is resolved.

In a still further example arrangement, there is provided a computer program for controlling a host data processing apparatus to provide an instruction execution environment, comprising: processing program logic to support execution of a transaction within a thread of data processing, the transaction comprising a sequence of instructions executed speculatively and for which the processing program logic is configured to prevent commitment of results of the speculatively executed instructions until the transaction has reached a transaction end point; and abort event program logic to cause execution of the transaction to be aborted when an abort event is detected before the transaction has reached the transaction end point, and to cause abort status information to be stored for later reference when determining whether to retry execution of the transaction; wherein when the abort event arises due to a given exception event of a given type, the abort event program logic is arranged to cause syndrome information to be captured for use when seeking to resolve the given exception event, and to cause the abort status information to identify that a retry of the transaction is suggested at least in the event that the given exception event is resolved.

In a yet further example arrangement, there is provided an apparatus comprising: processing means for performing data processing in response to instructions; and transactional memory support means for supporting execution of a transaction within a thread of data processing by the processing means, the transaction comprising a sequence of instructions executed speculatively and for which the processing means is configured to prevent commitment of results of the speculatively executed instructions until the transaction has reached a transaction end point; the transactional memory support means comprising abort event detection means for causing execution of the transaction to be aborted when an abort event is detected before the transaction has reached the transaction end point, and for causing abort status information to be stored for later reference when determining whether to retry execution of the transaction; wherein when the abort event arises due to a given exception event of a given type, the abort event detection means is for causing syndrome information to be captured for use when seeking to resolve the given exception event, and for causing the abort status information to identify that a retry of the transaction is suggested at least in the event that the given exception event is resolved.

### BRIEF DESCRIPTION OF THE DRAWINGS

The present technique will be described further, by way of illustration only, with reference to examples thereof as illustrated in the accompanying drawings, in which:

FIG. 1 is a block diagram of a data processing system in accordance with one example;

FIG. 2 illustrates example pseudocode, where the techniques described herein are not utilised;

FIG. 3 illustrates two threads executing the pseudocode of FIG. 2, and the occurrence of a load/store conflict between those threads;

FIG. 4 provides pseudocode illustrating a thread TO seeking to execute a transaction, but then adopting the fallback path due to a page fault issue causing an abort of the transaction, in accordance with an implementation not using the techniques described herein;

FIGS. 5A and 5B provide a flow diagram illustrating the operation of a data processing system in accordance with one example arrangement;

FIG. 6A is a flow diagram illustrating one example implementation of step 160 of FIG. 5B, and FIG. 6B illustrates steps that may then be taken when seeking to determine whether to retry the transaction, in accordance with an example implementation;

FIG. 7 is a flow diagram illustrating an alternative mechanism for implementing step 160 of FIG. 5B, in accordance with one example implementation;

FIG. 8 schematically illustrates the format of abort status information that may be provided in one example implementation;

FIG. 9 shows similar pseudocode to FIG. 2 but illustrates an additional mechanism that may be utilised in accordance with one example implementation to potentially avoid the use of the fallback path in the presence of page faults; and

FIG. 10 shows a simulator example that may be used.

### DESCRIPTION OF EXAMPLES

Data processing systems employing a transactional memory architecture allow atomic and strongly isolated execution of blocks of instructions forming a transaction. The atomicity ensures that a transaction is seen by other threads (which may also be referred to as agents) as one operation, and the isolation ensures the strict separation between transactional and non-transactional code. Hence, systems employing transactional memory architectures can allow access to a data structure whose composition is dynamic in nature in a way that enables a set of operations to complete atomically using the data structure without a requirement to use locking mechanisms or the like.

By avoiding the use of locking mechanisms or the like this can give rise to significant improvements in performance, as it can allow threads to concurrently process critical sections of code, rather than those threads being forced to execute in a serial manner dependent on the acquisition of a lock. However, it is still typically necessary to provide a fallback path within the software executing on the data processing system, so that in the event that a transaction cannot complete atomically, and hence is aborted, forward progress can still be guaranteed through the use of the fallback path, which may for example employ a locking mechanism (more generally referred to as a mutex (mutual exclusion object) mechanism).

The techniques described herein seek to reduce the reliance on the fallback path, and in particular provide a mechanism that can in some situations seek to resolve the cause of a transaction being aborted, so that that transaction can be retried rather than immediately relying on the fallback path. In situations where retrying of the transaction is successful, this can enable a significant improvement in performance.

In particular, in accordance with the techniques described herein, an apparatus is provided that has processing circuitry for performing data processing in response to instructions, and transactional memory support circuitry for supporting execution of a transaction within a thread of data processing by the processing circuitry. The transaction comprises a sequence of instructions executed speculatively, and for which the processing circuitry is configured to prevent commitment of results of the speculatively executed instructions until the transaction has reached a transaction end point.

There are two ways in which a transaction may finish. Firstly, the transaction may reach the earlier-mentioned transaction end point, meaning that the transaction can be committed, in that its execution has been performed atomically and in a strongly isolated manner. However, alternatively the transaction may be aborted, in a situation where the hardware cannot ensure the atomicity or the strong isolation of the transactional code, for example due to a conflicting access by another thread to one of the shared resources.

Hence, the transactional memory support circuitry may be provided with abort event detection circuitry to cause execution of the transaction to be aborted when an abort event is detected before the transaction has reached the transaction end point. The abort event detection circuitry in that situation causes abort status information to be stored for later reference when determining whether to retry execution of the transaction.

Furthermore, when the abort event arises due to a given exception event of a given type, the abort event detection circuitry is arranged to cause syndrome information to be captured for use when seeking to resolve the given exception event, and to cause the abort status information to identify that a retry of the transaction is suggested at least in the case that the given exception event is resolved. By arranging, in situations where the abort occurs due to a given type of exception event, for syndrome information to be captured that can be used to seek to resolve that exception event, this enables proactive steps to be taken to seek to improve the chances that the transaction will successfully complete if retried, hence allowing for certain transactions to be retried successfully. This can significantly improve performance by avoiding alternative, lower performance, mechanisms being triggered to seek to perform the data processing required by the transaction.

Depending on implementation, the above described technique may be arranged so that the abort status information identifies that a retry of the transaction is always recommended, and hence the retry may be attempted without seeking to determine whether the given exception event has been resolved. However, in an alternative implementation, it is possible for an attempt to be made to resolve the given exception event, and for the abort status information to identify that a retry of the transaction is suggested in situations where it is determined that the given exception event has been resolved.

The exception events that may give rise to the need to abort a transaction can take a variety of forms. For example, those exception events may be exceptions that occur due to instruction execution by the processing circuitry, or could be interrupts received by the apparatus, relating to activities occurring within the system asynchronously to the instruction execution. Further, such exception events may occur due to events requiring a change in privilege level of the processing circuitry (also referred to as a change in exception level), since such privilege level changes are not typically allowed whilst the processing circuitry is within transactional state (i.e. whilst the processing circuitry is executing a transaction).

Furthermore, the techniques described herein can be applied to various different types of exception event, and in particular to any type of exception event where there is an expectation that by capturing suitable syndrome information, there is a possibility of resolving the exception event so that the transaction could be successfully retried. One particular example case where it has been found that significant performance benefits can be realised by adopting the techniques described herein is in relation to page faults. In particular, whilst page faults may represent permanent faults, for example because the process being executed by the processing circuitry does not have suitable security/permission rights to access particular ranges of addresses in memory, it is often the case that page faults occur for a much more benign reason, in particular because the memory page referenced by an address has not yet been mapped into the processor's page tables.

Such benign page fault exception events can be resolved, for example by using operating system software to update the required mappings so that when execution is resumed the page fault no longer arises. However, in typical transactional memory techniques, no distinction may be made between the different types of exception events, and accordingly the use of the fallback path would often be adopted instead to seek to make forward progress. For instance, in such implementations the abort status information may merely capture that the abort occurred due to an operation being attempted in transactional state that was architecturally prohibited in transactional state. It may hence be expected that retrying the transaction is not appropriate, and that instead the fallback path should be used. However, by using the techniques described herein, it is possible to allow for steps to be taken to seek to resolve certain types of exception event, thereby improving the likelihood that the transaction can be successfully retried, and thereby avoiding the use of any fallback mechanism in such instances.

In one example implementation, when the abort event arises due to an exception event of a type other than the given type, the abort event detection circuitry is arranged to cause the abort status information to identify that a retry of the transaction is not recommended. Hence, a retry of the transaction can be avoided in situations where it is not considered appropriate to seek to use the techniques described herein in order to seek to resolve an exception event. In particular, it is realised that there are certain types of exception event for which there is no prospect of resolving the exception event, and accordingly for which a retry of the transaction would not achieve any useful result. Hence, the techniques described herein can be limited to certain specific exception event types, such as the earlier-mentioned page fault exception.

In one example implementation, the processing circuitry may be arranged, following abort of the transaction, to reference the abort status information in order to determine whether to retry the transaction, or whether instead to employ a fallback path provided by the software being executed on the processing circuitry, the fallback path providing a non-transaction based mechanism for performing the data processing required by the transaction. As discussed earlier, the fallback path can be used to ensure that forward progress can be made. Purely by way of example, if multiple threads are seeking to execute transactions concurrently with each other, and the accesses performed by those threads consistently give rise to conflicts, resulting in the need to abort the transactions, then forward progress could be made by using a fallback path that adopted the earlier described lock-based mechanism, so as to allow the processing required by each of those transactions to be performed sequentially.

There are a number of different ways in which the syndrome information can be captured, and an attempt can be made to seek to resolve the exception event. In one example implementation, the abort event detection circuitry is arranged to cause the syndrome information to be captured by causing that syndrome information to be stored within a syndrome register, and is then arranged to cause the abort status information to identify that a retry of the transaction is suggested by arranging for the abort status information to identify that the abort event arose due to an exception of the given type. The processing circuitry can then be arranged, on detecting with reference to the abort status information that the abort event arose due to an exception of the given type, to execute a resolve function that references the syndrome register in order to seek to resolve the exception using the syndrome information. The processing circuitry can then be further arranged, following completion of the resolve function, to seek to retry the transaction.

Hence, considering the earlier specific example where the exception event type of interest is a page fault exception, the syndrome register can be used to capture as syndrome information the address giving rise to the page fault, which may for example be the virtual address specified by the relevant instruction being executed. Further, the abort status information may be arranged to specifically identify that the abort event arose due to a page fault. The processing circuitry (for example as a result of the software executing on the processing circuitry) can then detect that a page fault gave rise to the abort of the transaction, and can take steps to seek to resolve the page fault, using the address captured within the syndrome register. As such functionality is implemented outside of the critical section of code that is seeking to be performed as a transaction, any suitable function can be adopted in order to seek to invoke and resolve the page fault. As a particular example, a helper function could be used that seeks to load a value from the address stored in the syndrome register and then store this value back to the same location. Typically that activity will invoke the page fault, and the earlier described steps, for example by branching to the operating system software, can be used to update the required page mappings, so that such a page fault will no longer occur. After such steps have been taken, the transaction can be retried with an increased chance of success.

However, there are other mechanisms that can be used to capture the required syndrome information and use that information to resolve the exception. For example, rather than capturing the required syndrome information in a syndrome register, and then ensuring the software executing on the processing system has been adapted to seek to resolve the exception event, the abort event detection circuitry may be arranged to trigger execution of an exception handling routine as part of the activity of aborting the transaction. During that process, the syndrome information can be captured by passing that syndrome information to the exception handling routine. Execution of the exception handling routine by the processing circuitry then seeks to resolve the exception using the syndrome information. When adopting such a mechanism, the abort event detection circuitry can then be further arranged to cause the abort status information to be stored once the exception handling routine has been completed. Such an approach avoids the need for a specific syndrome register to be architecturally exposed, but in some implementations such a syndrome register could still be provided if desired. Further, it means that the abort status information can be adapted dependent on the outcome of the exception handling routine.

In one example implementation, the abort status information is arranged to identify that a retry of the transaction is suggested when execution of the exception handling routine causes the exception to be resolved. Conversely, the abort status information may be arranged to identify that a retry of the transaction is not recommended when execution of the exception handling routine causes the exception to remain unresolved.

It should be noted that when using this alternative mechanism, there is no requirement for the abort status information to identify the exception type that gave rise to the abort event, since an attempt to seek to resolve the exception was taken as part of the abort process, through direct triggering of a suitable exception handling routine. Nevertheless, if desired, the abort status information can be further arranged to identify that the abort event arose due to an exception of the given type, as in some implementations it may still be considered useful to capture that information.

As mentioned earlier, the given type of exception to which the present techniques are applied can be varied dependent on implementation, but in one example implementation is a page fault exception. By causing the abort status information to identify that a retry of the transaction is suggested following abort of the transaction due to the given exception being a page fault exception, the apparatus is enabled to successfully retry the transaction in the event that the page fault exception is a transient exception, thereby avoiding a need to employ the fallback path provided by the software being executed on the processing circuitry. A transient exception is an exception that will not necessarily occur again if the transaction is retried, and may also be referred to herein as a resolvable exception, since as discussed above certain steps can be implemented with the aim of resolving the issue that gave rise to the exception previously, and hence avoiding the exception occurring again if the transaction is retried. Such transient exceptions should be contrasted with permanent exceptions which cannot be resolved, and hence which do not lend themselves to the use of the technique described herein, as there is no expectation that a retry of the transaction will be any more likely to succeed than the previous attempt made to execute the transaction.

Transactional code within a program can be identified in a variety of ways, but in one example implementation the sequence of instructions forming the transaction is delimited by a transaction start instruction and a transaction end instruction. A number of processes can be implemented on execution of a transaction start instruction. For example, checks may be made to determine whether it is possible to successfully enter transactional state, which would allow the code of the transaction to then be executed. Further, assuming transactional state can be successfully entered, the transactional memory support circuitry may comprise restoration state storage circuitry to store transaction restoration state data that is captured in response to the transaction start instruction, such transaction restoration state data capturing sufficient state data about the system to enable that state to be restored in the event that the transaction in due course needs to be aborted.

In implementations where the handling of the abort event directly causes an exception handling routine to be triggered, then in one example implementation the transactional memory support circuitry may be arranged to cause the transaction restoration state data to be restored before the exception handling routine is triggered. Accordingly, by the time the exception handler is triggered, processing is then proceeding along a non-speculative code path.

There are a number of ways in which the abort status information can be updated in the event of an abort of the transaction. In one example implementation, the abort event detection circuitry is arranged, in response to detection of the abort event, to cause the transaction start instruction to be re-executed by the processing circuitry in order to cause the abort status information to be stored for later reference when determining whether to retry execution of the transaction. Hence, in such implementations, execution of the transaction start instruction can be used as a mechanism to capture the required abort status information, and in this instance the re-execution of the transaction start instruction will determine that the transactional state cannot be entered, and the abort status information will be updated to identify the reasons why.

There are a number of steps that can be taken on occurrence of the earlier-mentioned transaction end instruction. However, in summary, when the transaction end instruction is reached, this means that the transaction can be successfully completed. Accordingly, the processing circuitry may be configured to prevent commitment of results of the speculatively executed instructions of the transaction until the transaction end instruction is reached.

Whilst the threads of data processing may execute directly on the host hardware of the apparatus, in an alternative arrangement a corresponding computer program may be provided for controlling a host data processing apparatus to provide an instruction execution environment for execution of threads of data processing. The computer program may comprise processing program logic to support execution of a transaction within a thread of data processing (in a similar way to the support for transactions discussed above for a hardware implementation). Further abort event program logic may be provided that causes execution of the transaction to be aborted when an abort event is detected before the transaction has reached a transaction end point, and which causes abort status information to be stored for later reference when determining whether to retry execution of the transaction. When the abort event arises due to a given exception event of a given type, the abort event program logic may cause syndrome information to be captured for use when seeking to resolve the given exception event, and may also cause the abort status information to identify that a retry of the transaction is suggested at least in the event that the given exception event is resolved.

Hence, a computer program may be provided which presents, to software executing above the computer program, a similar instruction environment to that which would be provided by an actual hardware apparatus having the features discussed above, even though there may not be any actual hardware providing these features in the host computer executing the computer program. Instead, the computer program, which may for example be a simulator or a virtual machine, may emulate the functionality of the hardware architecture by providing program logic (such as sets of instructions or data structures) which enables a generic host data processing apparatus to execute code intended for execution in an apparatus with transactional memory support, in a manner compatible with the results that would be achieved on the apparatus with transactional memory support. The computer program may be stored on a storage medium, and the storage medium may be a non-transitory storage medium.

Particular examples will now be described with reference to the Figures.

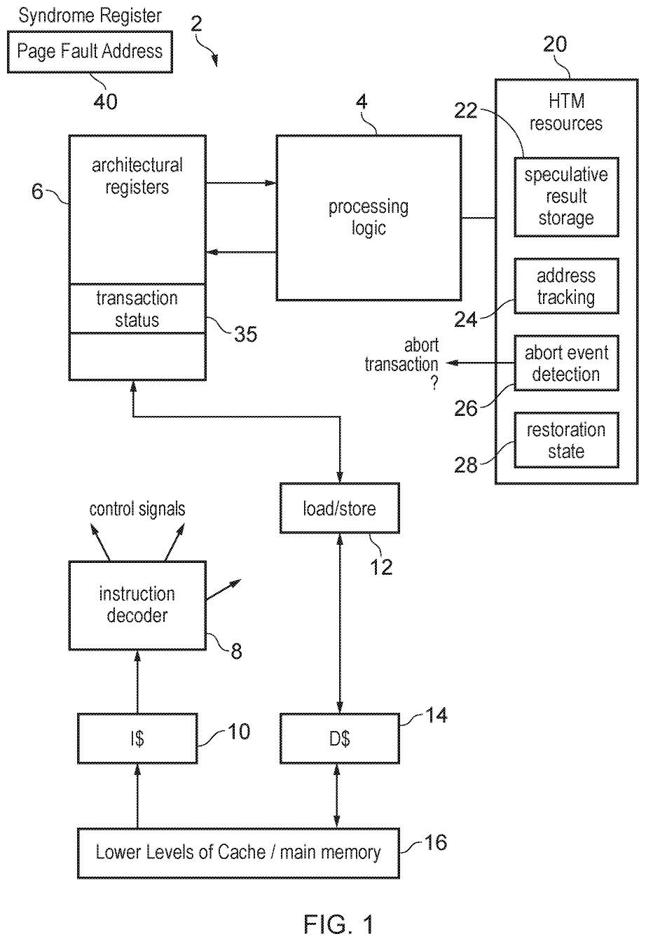

FIG. 1 illustrates an example of a data processing apparatus 2 with hardware transactional memory (HTM) support. The apparatus has processing logic 4 for executing instructions to carry out data processing operations. For example the processing logic 4 may include execution units for executing various types of processing operations, such as an arithmetic/logic unit (ALU) for carrying out arithmetic or logical operations such as add, multiply, AND, OR, etc.; a floating-point unit for performing operations on floating point operands; or a vector processing unit for carrying out vector processing on vector operands comprising multiple data elements. A set of architectural registers 6 is provided for storing operands for the instructions executed by the processing logic 4 and for storing the results of the executed instructions. An instruction decoder 8 decodes instructions fetched from an instruction cache 10 to generate control signals for controlling the processing logic 4 or other elements of the data processing apparatus 2 to perform the relevant operations. A load/store unit 12 is also provided to perform load operations (in response to load instructions decoded by the instruction decoder 8) to load a data value from a data cache 14 or lower levels of cache/main memory 16 into the architectural registers 6, and store operations (in response to store instructions decoded by the instruction decoder 8) to store a data value from the architectural registers 6 to the data cache 14 or lower levels of cache/main memory 16.

The apparatus 2 also has transactional memory support circuitry 20 which provides various resources for supporting hardware transactional memory (HTM). The HTM resources in the transactional memory support circuitry 20 may include for example speculative result storage 22 for storing speculative results of transactions, address tracking circuitry 24 for tracking the addresses accessed by a transaction, and abort event detection circuitry 26 for detecting abort events that require a transaction to be aborted. Such abort events can take a variety of forms. For example, an abort event may arise due an exception event occurring during a transaction, or due to conflicts between data accesses made by a transaction and data accesses made by other threads. The transactional memory support circuitry 20 may also include restoration state storage circuitry 28 for storing a snapshot of the architectural state data from the architectural registers 6 at the start of a transaction, so that this state can be restored to overwrite the speculative results of the transaction when a transaction is aborted.

The software executing on the apparatus 2 can be arranged to identify critical sections of code that are to be executed as a transaction. In one example implementation such critical sections of code are delimited by a transaction start instruction and a transaction end instruction, but alternatively any suitable mechanism for identifying blocks of code to be executed as transactions could be used. However, as discussed earlier, it is not guaranteed that it will be possible in all situations to execute the desired sections of code as transactions since, for example, data access conflicts between multiple threads concurrently seeking to execute transactions can result in transactions needing to be aborted. Hence, the program code will typically include a fallback path that can be used in order to provide a non-transaction based mechanism for performing the data processing required by the transaction, and in the event of transactions aborting that fallback path can be invoked in order to make forward progress.

However, as discussed earlier, it is desirable to only use the fallback path when absolutely necessary, as such a fallback path will typically require serialisation of the threads, and accordingly can result in performance degradation. In accordance with the techniques described herein, the abort event detection circuitry 26 is arranged so that, when an abort of a transaction is necessary due to an exception event of a given type, certain steps are taken to seek to resolve the reason for that exception occurring. The transaction can then be retried, and if successful the use of the fallback path can hence be avoided in that scenario.

The exception event type which causes the abort event detection circuitry 26 to take such steps may vary dependent on implementation, but for the purposes of the following discussion it will be assumed that the exception event type of interest is a page fault exception. When a page fault occurs, it has been found that in many situations that page fault can be resolved. In particular, whilst page faults can effectively represent permanent exceptions, for example because the process being executed does not have the required security or permission rights to access a region of memory seeking to be addressed, it is quite common that instead the page faults are effectively transient, for example due to the required pages of memory not yet being mapped into the processor's page tables. This can be resolved by standard mechanisms, for example by taking an exception to transition to operating system level code which has the appropriate level of privilege to handle this transient page fault, and hence which can update the relevant mappings so that when execution is resumed the page fault no longer occurs.

However, such a transition in privilege level cannot typically occur whilst within a transaction, and hence instead the transaction is aborted. In accordance with the techniques described herein, abortion of a transaction due to a page fault exception can be distinguished from other types of exception event that have given rise to an abort of the transaction, thereby enabling a different course of action to be taken in respect of such page fault exceptions. In particular, as will be discussed below, instead of merely deciding that the processing required by the transaction should instead be implemented using the fallback path, steps can be taken to seek to resolve the reason for the page fault exception arising, with the transaction then being retried. In situations where the page fault is indeed resolved, this can give rise to significant performance benefits by reducing occurrences where the fallback path needs to be utilised.

In accordance with the techniques described herein, when the abort event arises due to a page fault exception, the abort event detection circuitry 26 may be arranged to cause syndrome information to be captured for use when seeking to resolve the page fault exception, and in addition can cause abort status information captured when an abort occurs to identify that a retry of the transaction is suggested. This information in the abort status information is effectively a hint, indicating whether it is considered appropriate to retry the transaction or not. How the abort status information is utilised can vary dependent on implementations but, based on this hint, at least in certain situations the processing circuitry (or more particularly the software executing thereon) may reattempt to execute the transaction.

The syndrome information can be captured in a variety of ways, and indeed the information will take different forms dependent on the type of exception event for which the above described technique is being employed. However, for the specific example of a page fault exception, then the syndrome information may take the form of a page fault address identifying the address that the processing circuitry was seeking to access that gave rise to the page fault exception. This will for example specify a virtual address, and it may be that at the time of execution that virtual address was not able to be mapped to a physical address due to the processing circuitry not having access to appropriate page mapping information. In one example implementation, a syndrome register 40 may be provided within the system, into which that page fault address can be written by the abort event detection circuitry 26 in the event of detecting a page fault exception giving rise to the need to abort a transaction.

The above-mentioned abort status information, which is also referred to herein as transaction status information, can be stored in a variety of locations, and in one example implementation is stored within a register 35 forming one of the architectural registers 6. That transaction status register 35 can be populated with a variety of information that can be used to identify the reason for the failure of the transaction, but in accordance with one example implementation described herein is adapted so as to specifically identify a situation where the failure of the transaction resulted from a page fault exception. The transaction status information within the register 35 may also provide a retry field, which can be set or cleared to distinguish between situations where a retry of the transaction is suggested and situations where a retry of the transaction is not recommended, for example because it is not expected that a retry of the transaction will be successful. This information can then be used by the software executing on the processing circuitry when determining whether to retry the transaction, or whether instead to adopt the fallback path mechanism.

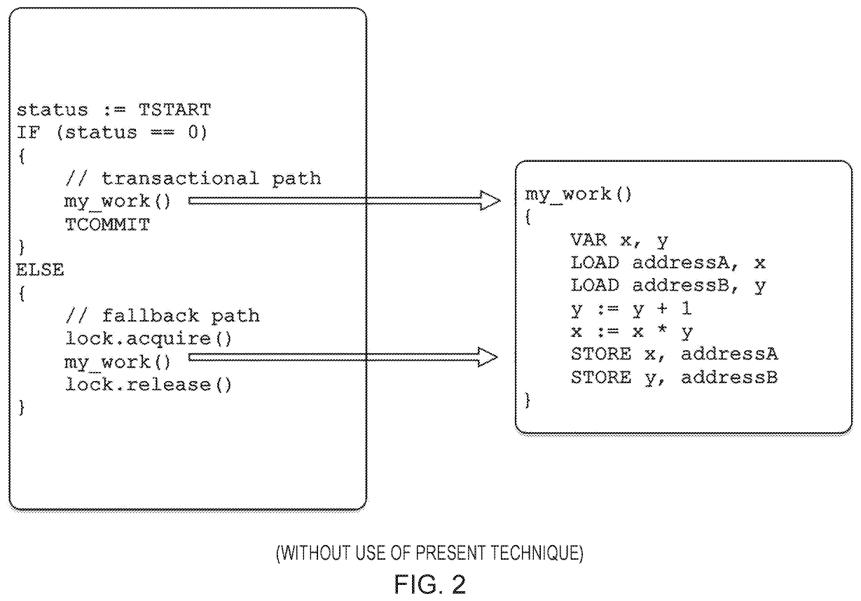

FIG. 2 shows example pseudocode for a program snippet, where the techniques described herein are not used. In this particular example, the objective is for a thread to execute the function “my_work( )” atomically, i.e. by executing the code of that function within a transaction. A thread executing on the processing circuitry will hence attempt to execute “my_work( )” in transactional state and, if this fails, will then fallback to executing the function using a fallback mechanism, in this case a lock-based mechanism. The processing performed within the transaction can take a variety of forms, but in this example involves setting the variables x and y to identify two registers, and then loading into those two registers the data found at address A and address B, respectively. The data then held in register y is incremented by one, and the data in register x is multiplied by the updated data value in register y. The contents of register x are then stored back to address A whilst the contents of register y are then stored back to address B. If all of those operations successfully complete atomically, then the speculative result storage 22 will contain all of the results, and those results can then be committed when the commit point is reached, in one example this being reached when a transaction end instruction is encountered.

However, if the transaction fails, then the restoration state in storage 28 will be used to restore the processor state to the state that existed before the transaction was started. Further, the transaction status information (i.e. the earlier-mentioned abort status information) will be updated to a non-zero value, and accordingly will cause the “else” section of code shown in FIG. 2 to be executed, resulting in the function “my_work( )” only being executed once the thread has acquired a lock. Whilst the lock is acquired by that thread, no other thread can acquire the lock, and accordingly cannot seek to concurrently execute the function my_work( ), or access memory addresses associated with function.

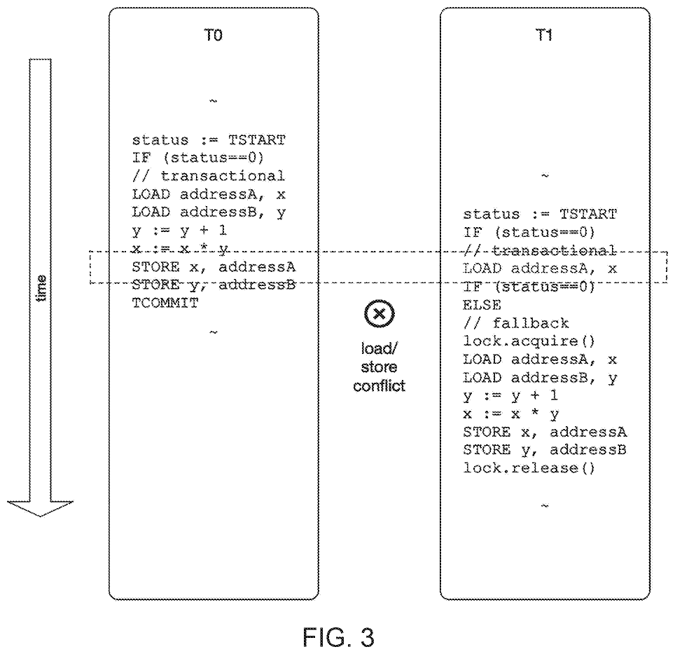

FIG. 3 is a diagram illustrating two threads (T0 and T1) concurrently seeking to execute the pseudocode of FIG. 2. In this example, both threads manage to enter into transactional state, and accordingly begin to execute the transaction. However, as shown in FIG. 3, a load/store conflict occurs when thread T1 attempts to load from address A, it being noted at this point that address A is being written to by thread T0 (address A being within a write set of addresses for the transaction). This interaction is not permitted as it causes a race condition, and accordingly the microarchitecture detects this situation and forces the transaction of T1 to abort. T1 restores its architectural state to the checkpointed data that was stored as the restoration state 28 when the transaction start instruction for T1 was executed. During the transaction abort process, the transaction start instruction is re-executed, but in this instance merely detects that transactional state cannot be entered, and updates the abort status information 35 to identify the failure of the transaction. Due to the processor detecting the fact that the transaction status information is now a non-zero value, then the fallback path is adopted for thread T1, and as such the control flow steers the program counter value to the fallback path where the functionality required by the my_work function is executed under the mutual exclusion of a lock.

Exception events can take a variety of forms, for example exceptions that occur due to instruction execution, interrupts that occur asynchronously to instruction execution, and exceptions that occur due to privilege level changes, and typically any of these types of exception event are not allowed to occur whilst the processing circuitry is in transactional state. Hence, if a page fault occurs inside a transaction, the transaction will typically abort, and re-execution of the transaction start instruction will return a non-zero value to form the abort status information. This abort status information may for example indicate that an operation was attempted in transactional state that was architecturally prohibited, and a retry hint may indicate that the transaction is unlikely to succeed if retried. However, with such information there may be no ability to detect a form of failure that might be transient, and hence for which a successful retry of the transaction may be possible if the reasons for the exception can be resolved. Without the use of the technique described herein it may typically not be known which instruction caused the failure and whether the failure was due to a page fault exception or some other type of exception.

Whilst reattempting to execute the transaction is architecturally permitted in some systems, it is expected that this would likely lead to the same failure, and accordingly it is typically the case that the program will then steer the program counter towards the fallback path. This in turn will cause other threads to abort their transactions since the lock address will typically be added to the read set of those transactions, and accordingly acquisition of the lock will cause the other transactions to abort. Those other threads will then need to wait for the lock to be released before they can resume execution of the code. This can ultimately mean that a single page fault occurring within a transaction can cause an entire system to stall except for one thread. Indeed, it has been observed that for certain programs this can mean that a pathological performance degradation is experienced when seeking to execute transactions within those programs, due to an abundance of page faults occurring inside the transactions.

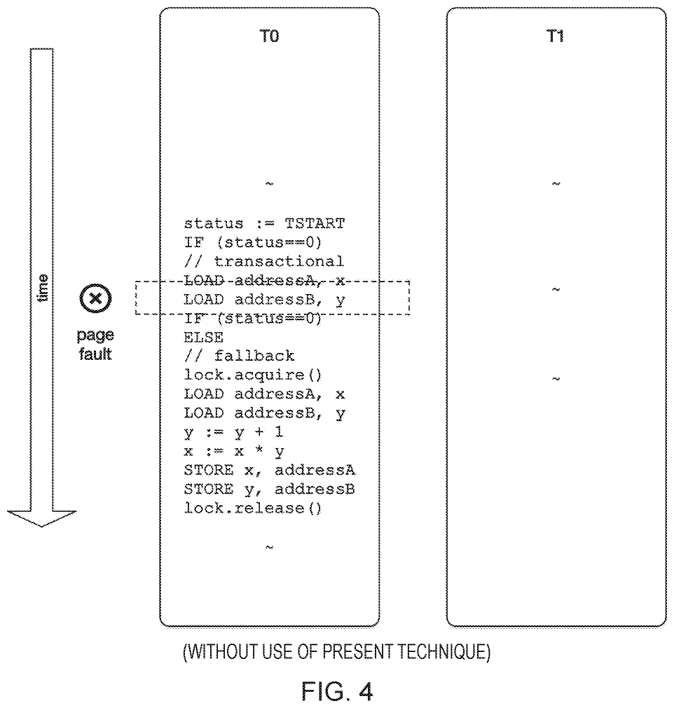

FIG. 4 illustrates thread T0 attempting to execute the function my_work within a transaction. In this example, a page fault occurs when loading from address B. This causes the transaction to abort, and the control flow to steer the program counter to the fallback path. Even though the other thread T1 is not running any code it is still not architecturally permitted (nor safe) to handle the page fault within the transaction. The techniques described herein provide a mechanism to avoid this pathological behaviour.

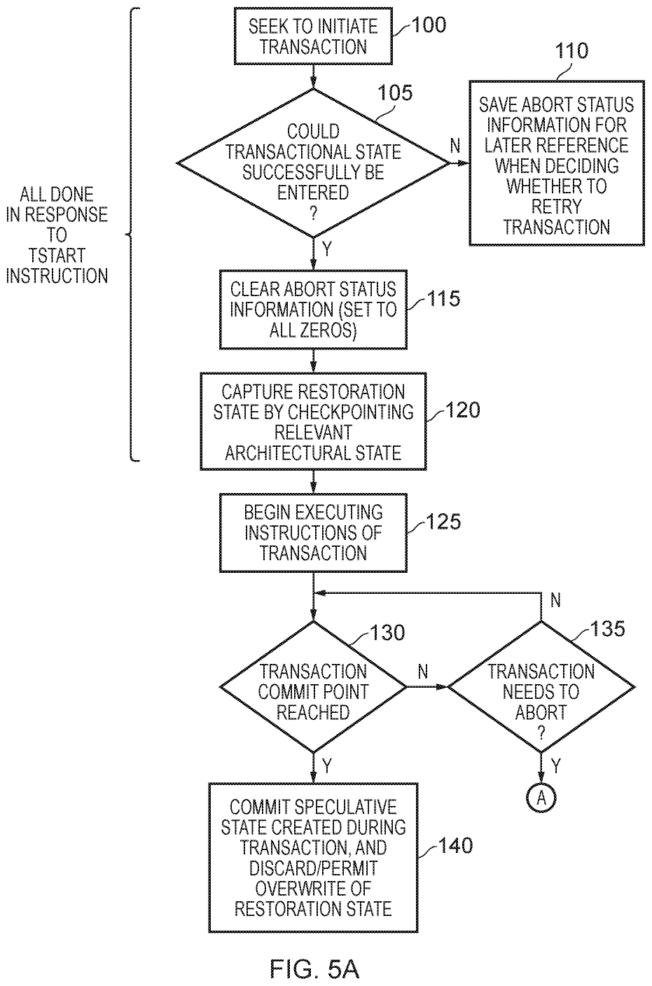

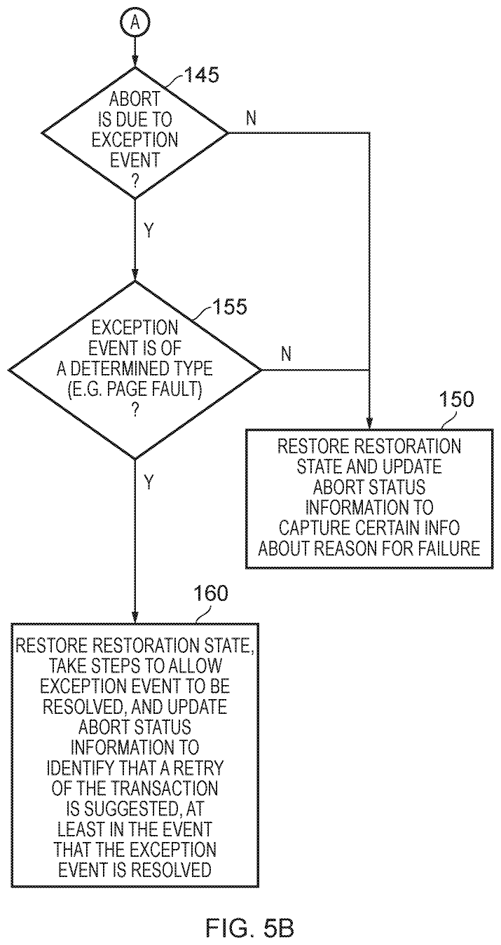

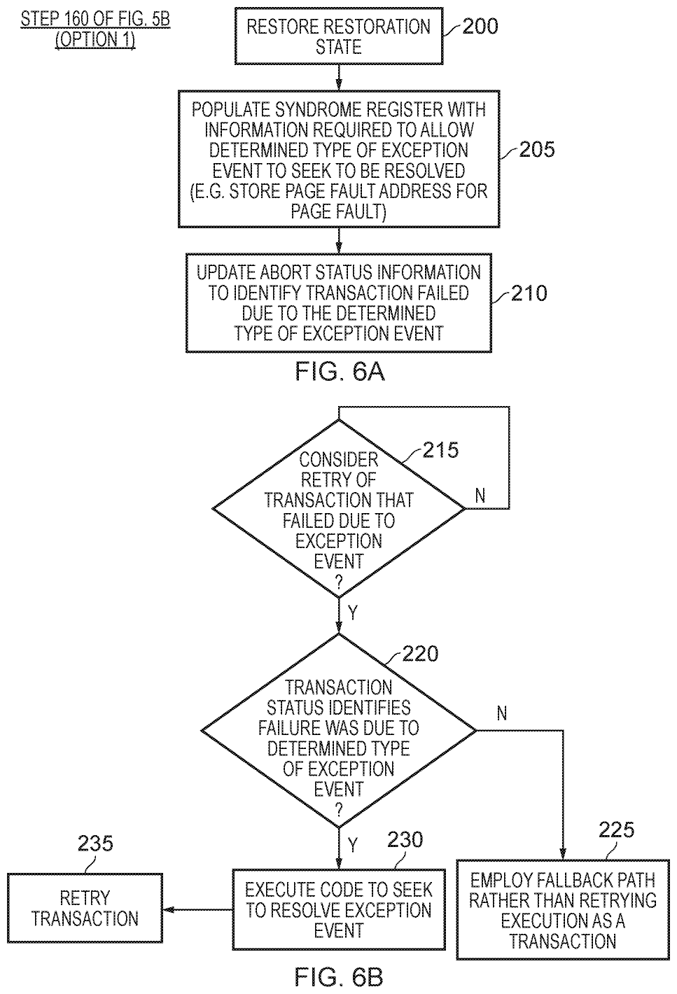

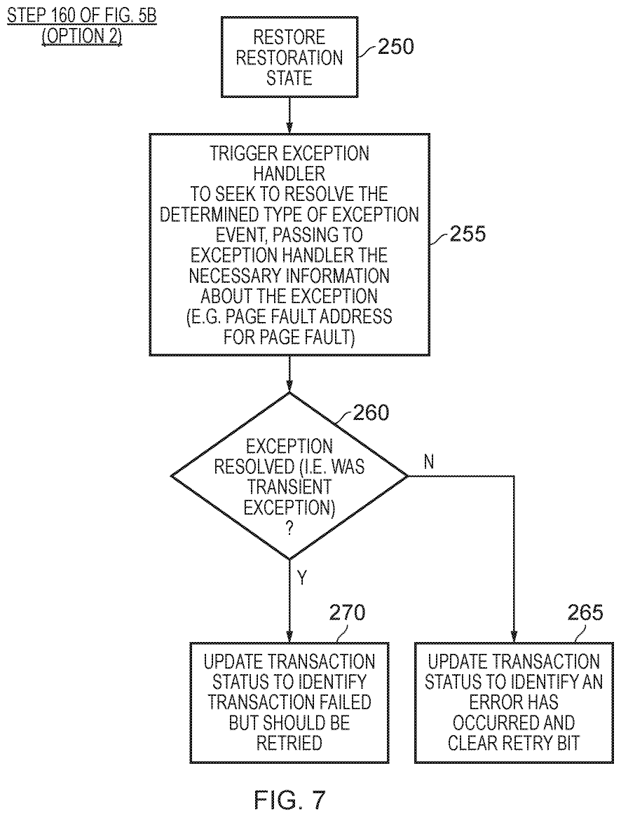

In particular, FIGS. 5A and 5B provide a flow diagram illustrating steps performed in one example implementation, that can avoid the need to use the fallback path on occurrence of resolvable page faults that may occur within a transaction. At step 100, the processing circuitry seeks to initiate a transaction. There are various ways to initiate a transaction, and in some HTM systems specific instructions are used to start and end transactions. Hence, in one example implementation initiation of the transaction occurs as a result of executing a transaction start instruction (also referred to herein as a TSTART instruction). In response to seeking to initiate a transaction, it is determined at step 105 whether transactional state can successfully be entered. In particular, a number of checks can be performed in order to determine whether it is possible to enter transactional state or not, and if transactional state cannot be entered, then at step 110 abort status information is saved for later reference when deciding whether to retry the transaction. This abort status information can capture a variety of information, but in one example implementation seeks to capture information identifying the reason for failure of the transaction, and can provide a retry field to hint as to whether a retry of the transaction is suggested or not.

If it is determined that the transactional state can successfully be entered, then the abort status information is initialised at step 115. This can be done in a variety of ways, but in the implementation shown in FIG. 1 is achieved by clearing the abort status information, for example by setting that information to all zeroes. At step 120, restoration state is then captured by checkpointing the relevant architectural state of the processor, that restoration state for example being stored within the earlier-mentioned restoration state storage circuitry 28 of the HTM resources 20.

The abort status information can take a variety of forms, but in one specific example implementation comprises 64 bits of information that are produced by execution of the TSTART instruction to identify whether transactional state has been successfully entered, or to capture the reasons why transactional state has not been successfully entered (in the event that step 110 is reached). As shown in FIG. 5A, in the example implementation where initiation of the transaction is sought by executing a TSTART instruction, then all of steps 105, 110, 115, 120 may be performed in response to execution of the TSTART instruction.

Assuming the transaction state is successfully entered, then following step 120 the processing circuitry begins executing the instructions of the transaction at step 125. Whilst performing execution of the transaction, it is determined at step 130 whether the transaction commit point has been reached, which in one example implementation occurs when a transaction end instruction (also referred to herein as a transaction commit (TCOMMIT) instruction) is encountered. However, in the absence of reaching the transaction commit point, it is determined at step 135 whether the transaction needs to abort. As discussed earlier a variety of scenarios can give rise to the need to abort the transaction, but assuming the transaction does not need to be aborted the process returns to step 130.

It will be appreciated that at some point the transaction commit point will be reached or it will be determined that the transaction needs to be aborted. If the transaction commit point is reached, then at step 140 the speculative state created during the transaction (i.e. that information stored within the speculative result storage 22) is committed, and accordingly the restoration state can thereafter be discarded or permitted to be overwritten. At this point, processing of the transaction has successfully completed.

However, if it is determined at step 135 that it is necessary to abort the transaction, it is then determined at step 145 whether the abort is due to an exception event. As discussed earlier, there are other reasons that can give rise to the need to abort the transaction, for example the earlier-mentioned load/store conflict discussed with reference to FIG. 3. If the abort is not due to an exception event, then the process proceeds to step 150 where the restoration state within the restoration state storage 28 is restored, and then the abort status information is updated to capture certain information about the reason for the failure of the transaction. This may include the earlier-mentioned retry hint information, along with various information indicative of the reason for the failure of the transaction.

If at step 145 it is determined that the abort is due to an exception event, it is then determined at step 155 whether the exception event is of a determined type. In the example discussed herein, it will be assumed that the determined type is a page fault exception, but it will be also be appreciated that the techniques described herein are not limited to use in association with page fault exceptions, and any other suitable form of exception could also be processed in the manner described herein. If the exception event is not due to the determined type of exception, then the process proceeds to step 150, where again the restoration state is restored and the abort status information is updated. For exception events, the information captured within the abort status information might typically identify that a transaction retry is not recommended, since it may be expected that such a retry of the transaction will also result in failure.

However, if it is determined at step 155 that the exception event is of the determined type, for example is a page fault exception, then at step 160 the restoration state is again restored, but in addition steps are taken to allow the exception event to be resolved, and the abort status information is updated to identify that a retry of the transaction is suggested, at least in the event that the exception event is resolved. There are various ways in which steps can be taken to seek to resolve the exception event, and two alternative examples will be discussed herein with reference to FIGS. 6A, 6B and 7 (the first involving capturing the syndrome information in a syndrome register for subsequent reference, and the second involving triggering an exception handler that seeks to automatically resolve the exception event without needing to provide an architecturally exposed syndrome register to hold the syndrome information). Further, there are various ways in which the abort status information can be updated to suggest a retry of the transaction, and again these will be discussed with reference to the following figures.

FIG. 6A is a flow diagram illustrating steps that can be performed in order to implement step 160 of FIG. 5B, in one example implementation. At step 200, the restoration state is restored. Further, at step 205 the syndrome register 40 is populated with information required to allow the determined type of exception event to seek to be resolved. For the earlier-mentioned page fault exception, the address that caused the page fault exception may be stored within the syndrome register, and this for example may be a virtual address specified by the instruction being executed.

At step 210, the abort status information is updated to identify that the transaction failed due to the determined type of exception event. Hence, considering the example of a page fault exception, the abort status information created as a result of the re-execution of the TSTART instruction is modified so that it unambiguously identifies that the transaction failed due to a page fault instead of any other type of exception.

FIG. 6B is a flow diagram illustrating steps performed when it is considered whether the transaction should be retried. These steps will not typically be implemented by the microarchitecture, but instead may be implemented by a suitable algorithm, as for instance may be provided in the user code executed on the system. At step 215, it is determined whether a retry of the transaction that failed due to an exception event is to be considered. In one example implementation, the consideration of a retry may occur immediately after the transaction aborted, but in alternative implementations there could be some delay between the transaction being aborted, and consideration of retrying of the transaction being assessed.

When it is determined appropriate to consider a retry of the transaction at step 215, then at step 220 it is determined whether the transaction status information identifies that the failure was due to the determined type of exception event, i.e. for the example given above whether the transaction failed due to a page fault exception. If not, then at step 225 the fallback is employed rather than retrying execution as a transaction.

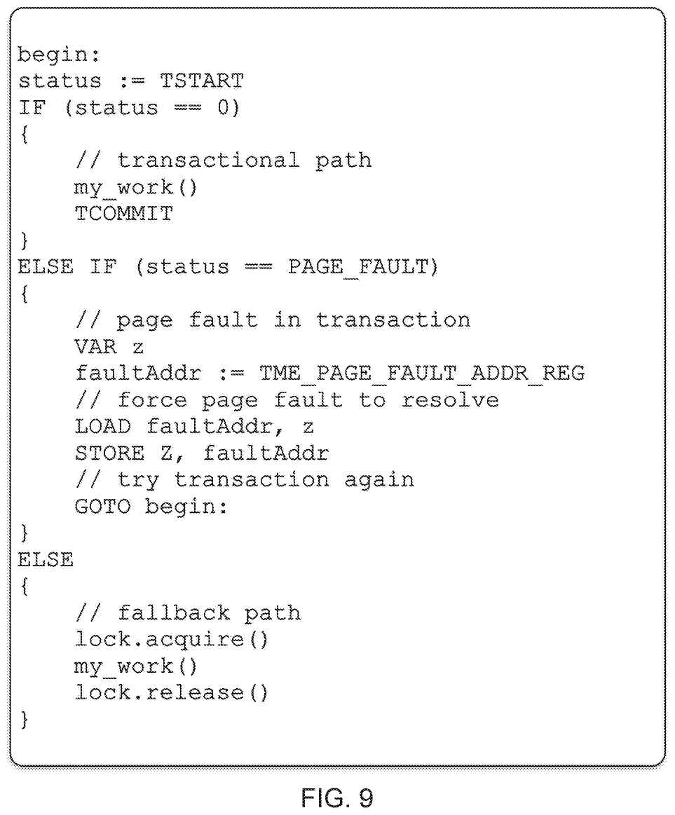

However, if it is determined from the transaction status information that the failure was due to the determined type of exception event, then at step 230 code is executed to seek to resolve the exception event. This code can take a variety of forms, and indeed could be any helper function that seeks to re-invoke the page fault, and thereby cause the page fault to be resolved. It should be noted that at this point the code being executed is outside of the critical section of code defined by the transaction, and accordingly there is a great deal of flexibility as to the mechanisms that can be used to seek to resolve the exception event. At this point, the information stored within the syndrome register 40 is referenced, since as discussed earlier that will identify relevant information. In particular, for a page fault exception, it will identify the virtual address that gave rise to the page fault exception occurring, and accordingly a further access to that virtual address can be used as a mechanism for re-invoking the page fault, and seeking a resolution of that page fault exception. As will be discussed with reference later to FIG. 9, one suitable mechanism that can be used is merely to seek to load data from the address identified in the syndrome register, and thereafter store that data back to memory, and during this process the page mappings available to the processing circuitry may typically be updated so that subsequently the page fault will not rise.

Following execution of the code at step 230, a retry of the transaction is attempted at step 235. In one example implementation this is achieved by returning to the processing at the top of FIG. 5A, i.e. by seeking to initiate the transaction at step 100. At this point, it is likely that the transaction will successfully be started, and when the relevant instruction is encountered that used the virtual address that previously had given rise to the page fault, it is expected that this time round no such page fault exception will be encountered. Accordingly, assuming no other reasons give rise to the need to abort the transaction, it is expected that the transaction will now complete successfully.

FIG. 7 is a flow diagram illustrating an alternative mechanism that can be used to implement step 160 of FIG. 5B, in one example implementation. At step 250, the restoration state is restored, and thereafter, as part of the abort handling, an exception handler is triggered to seek to resolve the determined type of exception event. During this process, the required syndrome information can be passed to the exception handler to provide the necessary information about the exception, for example the page fault address (i.e. the address that gave rise to the page fault exception). It should be noted that since the restoration state has now been restored, then at step 255 a non-speculative code path is now being followed, and hence the exception handler is external to the code defining the transaction.

At step 260, it is determined whether the exception has been resolved by virtue of execution of the exception handler, and hence it is determined whether the exception was a transient exception. If it was not, then at step 265 the transaction status information is updated to identify that an error has occurred, and the retry bit is cleared. In particular, it is expected that a retry of the transaction is unlikely to be successful, and hence by clearing the retry bit it can be indicated that a retry of the transaction is not recommended.

However, if at step 260 it is determined that the exception has been resolved, then at step 270 the transaction status information can be updated to identify that the transaction failed, but that it should be retried. In particular, a retry of the transaction is recommended, since there is an expectation that a retry of the transaction will be successful.

When adopting the approach of FIG. 7, there is no requirement for the transaction status information to identify that the transaction failed due to the particular type of exception (i.e. in the example discussed above there is no need to identify that the transaction failed due to a page fault exception), since the steps taken to seek to resolve the failure of the transaction have already been taken at step 255 by invoking the exception handler. However, if desired, then at either of steps 265, 270, the transaction status information can be updated to identify that the failure was due to a page fault exception, as in some implementations it may be considered useful to capture that information.

Irrespective of which of the above approaches is taken (i.e. whether the approach of FIGS. 6A/6B is used or the approach of FIG. 7 is used), it will be appreciated that the technique allows the reason for the page fault to seek to be resolved and for the transaction to be retried, rather than immediately steering the program counter to the fallback path. This can avoid the need to use the fallback path in a significant number of situations, and hence allow more concurrency in the system, thereby improving performance.

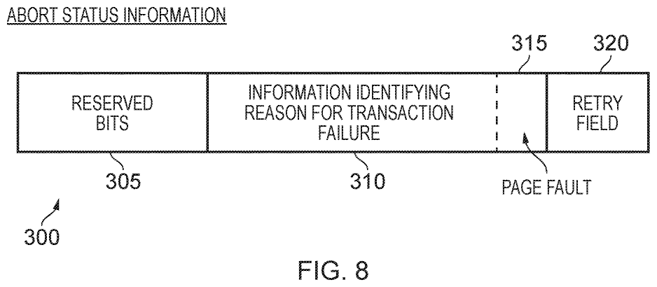

FIG. 8 illustrates an example form of the abort status information maintained within the transaction status register 35. A field 310 comprising multiple bits can be used to capture a variety of information used to identify the reason for the transaction failure, and in accordance with one example implementation a page fault sub-field is provided to specifically identify when a transaction failed due to a page fault. This sub-field 315 may be, in one example implementation, a single bit which is set to identify that the failure was due to a page fault and which is cleared to identify that the failure was not due to a page fault. As discussed earlier, when using the optional approach of FIG. 7, there may be no need to capture this page fault information.

As also shown in FIG. 8, a retry field 320 is provided to provide a hint as to whether a retry of the transaction is expected to be successful or not. Hence, the retry field 320 can be seen as providing a retry suggestion, for example being set to identify that a retry of the transaction is suggested, and being cleared to identify that a retry of the transaction is not recommended. As discussed earlier, the retry field can be set in situations where the exception that gave rise to the transaction failure was a page fault exception. In the example of the approach of FIGS. 6A/6B, the retry field may be set whenever the failure occurs due to a page fault exception, whereas when using the approach of FIG. 7 the retry field may in one example only be set if performance of the exception handling routine appears to have resolved the page fault issue.

As also shown in FIG. 8, a number of reserved bits 305 may be provided, allowing any other additional information of interest to be captured within the abort status information, but that information is not relevant to the technique described herein.

FIG. 9 shows similar pseudocode to that discussed earlier with reference to FIG. 2, but includes a revised mechanism that incorporates the feature discussed earlier. If a transaction fails there is now an additional check to determine if this was caused by a page fault. If this is the case, then the faulting address is found within the syndrome register (which is referred to in FIG. 9 as the TME_PAGE_FAULT_ADDR_REG). Through use of this additional check, the page fault can be re-invoked outside of the critical section of code defined by the transaction in which ever way the programmer prefers. In the particular example shown in FIG. 9, this occurs by loading a value from the page fault address and then storing the value back to the same location. During this process, it is expected that the page fault will be re-invoked, and that the operating system software will then page in the required address mapping in order to allow the specified virtual address to be mapped into a physical address in memory. In particular, one of the load or store instructions may cause an exception to be triggered in order to resolve the page fault. After this process, the transaction can be retried with an increased chance of succeeding. In the example shown in FIG. 9 this is achieved with the “GOTO” statement.

By virtue of the technique illustrated schematically in FIG. 9, then transient page fault exceptions, i.e. those page faults that can be resolved, do not need to cause the fallback path to be utilised when the transaction first fails. Instead, an attempt is made to seek to resolve such page faults, and then the transaction is reattempted. In the absence of any further issues causing the transaction to fail, then the transaction will complete successfully, avoiding the need to use the fallback path. However, if the transaction does fail due to other reasons, then the fallback path is still provided and can be used.

Further, if the page fault is permanent and hence cannot be resolved (for example due to the code seeking to access the memory address in question having insufficient security/permission rights), then the program will typically fail and exit as per normal expected behaviour.

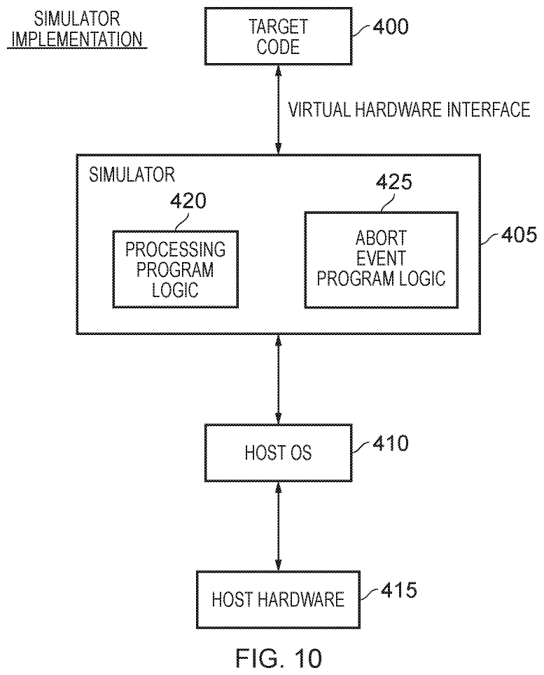

FIG. 10 illustrates a simulator implementation that may be used. While the earlier-described examples implement the present technique in terms of apparatus and methods for operating specific processing hardware supporting the techniques concerned, it is also possible to provide an instruction execution environment in accordance with the examples described herein which is implemented through the use of a computer program. Such computer programs are often referred to as simulators, insofar as they provide a software based implementation of a hardware architecture. Varieties of simulator computer programs include emulators, virtual machines, models and binary translators, including dynamic binary translators. Typically, a simulator implementation may run on a host processor 415, optionally running a host operating system 410, supporting the simulator program 405. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, pages 53 to 63.

To the extent that example implementations have previously been described with reference to particular hardware constructs or features, in a simulated implementation equivalent functionality may be provided by suitable software constructs or features. For example, particular circuitry may be implemented in a simulated implementation as computer program logic. Similarly, memory hardware, such as a register or cache, may be implemented in a simulated implementation as a software data structure. In arrangements where one or more of the hardware elements referenced in the previously described examples are present on the host hardware (for example the host processor 415), some simulated implementations may make use of the host hardware, where suitable.

The simulator program 405 may be stored on a computer readable storage medium (which may be a non-transitory medium), and provides a virtual hardware interface (instruction execution environment) to the target code 400 (which may include applications, operating systems and a hypervisor) which is the same as the hardware interface of the hardware architecture being modelled by the simulator program 405. Thus, the program instructions of the target code 400 may be executed from within the instruction execution environment using the simulator program 405, so that a host computer 415 which does not actually have the hardware features of the apparatus 2 discussed above can emulate these features. The simulator program 405 may include processing program logic 420 to support execution of a transaction within a thread of data processing, and abort event program logic 425 to cause execution of the transaction to be aborted when an abort event is detected before the transaction has reached a transaction end point. The abort event program logic will cause abort status information to be captured for later reference when determining whether to retry execution of the transaction, and can implement the functionality discussed earlier in order to cause syndrome information to be captured, and for the abort status information to identify that a retry of the transaction is suggested at least in the event that the given exception event is resolved. Hence, the various program logic functions can provide functionality that is equivalent to the corresponding hardware blocks shown in FIG. 1.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
processing circuitry to perform data processing in response to instructions; and
transactional memory support circuitry to support execution of a transaction within a thread of data processing by the processing circuitry, the transaction comprising a sequence of instructions executed speculatively and for which the processing circuitry is configured to prevent commitment of results of the speculatively executed instructions until the transaction has reached a transaction end point;
the transactional memory support circuitry comprising abort event detection circuitry to cause execution of the transaction to be aborted when an abort event is detected before the transaction has reached the transaction end point, and to cause abort status information to be stored for later reference when determining whether to retry execution of the transaction;
wherein when the abort event arises due to a given exception event of a given type, the abort event detection circuitry is arranged to cause syndrome information to be captured for use when seeking to resolve the given exception event, and to cause the abort status information to identify that a retry of the transaction is suggested at least in the event that the given exception event is resolved.

2. The apparatus as claimed in claim 1, wherein:
when the abort event arises due to an exception event of a type other than the given type, the abort event detection circuitry is arranged to cause the abort status information to identify that a retry of the transaction is not recommended.

3. The apparatus as claimed in claim 1, wherein:
the processing circuitry is arranged, following abort of the transaction, to reference the abort status information in order to determine whether to retry the transaction, or whether instead to employ a fallback path provided by the software being executed on the processing circuitry, the fallback path providing a nontransaction based mechanism for performing the data processing required by the transaction.

4. The apparatus as claimed in claim 3, wherein:
the abort event detection circuitry is arranged to cause the syndrome information to be captured by causing the syndrome information to be stored in a syndrome register, and is arranged to cause the abort status information to identify that a retry of the transaction is suggested by arranging the abort status information to identify that the abort event arose due to an exception of the given type; and the processing circuitry is arranged, on detecting with reference to the abort status information that the abort event arose due to an exception of the given type, to execute a resolve function that references the syndrome register in order to seek to resolve the exception using the syndrome information, the processing circuitry being further arranged, following completion of the resolve function, to seek to retry the transaction.

5. The apparatus as claimed in claim 3, wherein:
the abort event detection circuitry is arranged to trigger execution of an exception handling routine by the processing circuitry, during which the syndrome information is captured by passing the syndrome information to the exception handling routine, wherein execution of the exception handling routine by the processing circuitry seeks to resolve the exception using the syndrome information; and the abort event detection circuitry is further arranged to cause the abort status information to be stored once the exception handling routine has been completed.

6. The apparatus as claimed in claim 5, wherein the abort status information is arranged to identify that a retry of the transaction is suggested when execution of the exception handling routine causes the exception to be resolved.

7. The apparatus as claimed in claim 5, wherein the abort status information is arranged to identify that a retry of the transaction is not recommended when execution of the exception handling routine causes the exception to remain unresolved.

8. The apparatus as claimed in claim 5, wherein the abort status information is further arranged to identify that the abort event arose due to an exception of the given type.

9. The apparatus as claimed in claim 1, wherein the given type of exception is a page fault exception.

10. The apparatus as claimed in claim 9, wherein by causing the abort status information to identify that a retry of the transaction is suggested following abort of the transaction due to the given exception being a page fault exception, the apparatus is enabled to successfully retry the transaction in the event that the page fault exception is a transient exception, thereby avoiding a need to employ a fallback path provided by the software being executed on the processing circuitry, where the fallback path provides a non-transaction based mechanism for performing the data processing required by the transaction.

11. The apparatus as claimed in claim 1, wherein the sequence of instructions forming the transaction is delimited by a transaction start instruction and a transaction end instruction.

12. The apparatus according to claim 11, wherein the transactional memory support circuitry comprises restoration state storage circuitry to store transaction restoration state data captured in response to the transaction start instruction.

13. The apparatus according to claim 12, wherein the transactional memory support circuitry is arranged to cause the transaction restoration state data to be restored in response to the abort event.

14. The apparatus as claimed in claim 13, wherein the transactional memory support circuitry is arranged to cause the transaction restoration state data to be restored before the exception handling routine is triggered.

15. The apparatus as claimed in claim 11, wherein the abort event detection circuitry is arranged, in response to detection of the abort event, to cause the transaction start instruction to be re-executed by the processing circuitry in order to cause the abort status information to be stored for later reference when determining whether to retry execution of the transaction.

16. The apparatus according to claim 11, wherein the processing circuitry is configured to prevent commitment of results of the speculatively executed instructions until the transaction end instruction is reached.

17. A method of handling transactions in an apparatus, comprising:
employing processing circuitry to perform data processing in response to instructions;
employing transactional memory support circuitry to support execution of a transaction within a thread of data processing by the processing circuitry, the transaction comprising a sequence of instructions executed speculatively and for which the processing circuitry is configured to prevent commitment of results of the speculatively executed instructions until the transaction has reached a transaction end point; aborting execution of the transaction when an abort event is detected by the transactional memory support circuitry before the transaction has reached the transaction end point;
on aborting execution of the transaction, storing abort status information for later reference when determining whether to retry execution of the transaction; and
when the abort event arises due to a given exception event of a given type, capturing syndrome information for use when seeking to resolve the given exception event, and causing the abort status information to identify that a retry of the transaction is suggested at least in the event that the given exception event is resolved.

18. A computer program for controlling a host data processing apparatus to provide an instruction execution environment, comprising:
processing program logic to support execution of a transaction within a thread of data processing, the transaction comprising a sequence of instructions executed speculatively and for which the processing program logic is configured to prevent commitment of results of the speculatively executed instructions until the transaction has reached a transaction end point; and
abort event program logic to cause execution of the transaction to be aborted when an abort event is detected before the transaction has reached the transaction end point, and to cause abort status information to be stored for later reference when determining whether to retry execution of the transaction; wherein when the abort event arises due to a given exception event of a given type, the abort event program logic is arranged to cause syndrome information to be captured for use when seeking to resolve the given exception event, and to cause the abort status information to identify that a retry of the transaction is suggested at least in the event that the given exception event is resolved.
